(19) United States
(12) Patent Application Publication
(10) Pub. No.: US 2007/0204494 A1
(43) Pub. Date: Sep. 6, 2007

(54) Napkin holder merchandizing strip

(76) Inventor: Jerry Lacy, Rocky Mount, NC (US)

Correspondence Address: CARDINAL LAW GROUP, Suite 2000, 1603 Orrington Avenue, Evanston, IL, 60201, US

(21) Appl. No.: 11/365,367

(22) Filed: Mar. 1, 2006

(51) Int. Cl. G09F 3/00

(52) U.S. Cl. 40/312

(57) ABSTRACT

An advertising display device for a napkin holder that includes a top portion having a length to extend across a top surface of the napkin holder, first and second side portions extending from the top portion, the side portions each having a length to extend across a side of the napkin holder, first tab portion extending from the first side portion, and a second tab portion extending from the second side portion, and an attachment device positioned on an end of at least one of the first and second tab portions to allow attachment of the first and second tab portions on a bottom side of the napkin holder wherein the tab portions have a width sized to fit between feet of the napkin holder and wherein printed advertisement is disposed on at least one of the top portion and side portions.

### FIELD OF INVENTION

The invention generally relates to advertising. More specifically, this invention relates to the advertising on a napkin holder using an advertising display device.

### BACKGROUND OF THE INVENTION

For years, restaurant owners have experimented with various ways of advertising their products to customers. From display windows to placemats, the purpose of the advertising is to catch the attention of the customer while in the restaurant. Customers spend a considerable amount of time sitting at tables in restaurants, thus, advertising at these sites would be beneficial. Currently, stand-alone advertising is used. However, customers generally do not appreciate the clutter created by the stand-alone advertising and will generally move the advertising aside. This drastically minimizes the effectiveness of the advertising at the table.

It is desirable to provide advertising at a table that overcomes these and other disadvantages.

### SUMMARY OF THE INVENTION

One aspect of the invention provides an advertising display device for a napkin holder. The advertising display device for a napkin holder includes a top portion having a length to extend across a top surface of the napkin holder and first and second side portions extending from the top portion. The side portions each have a length to extend across a side of the napkin holder. The display device also includes a first tab portion extending from the first side portion, and a second tab portion extending from the second side portion, and an attachment device positioned on an end of at least one of the first and second tab portions to allow attachment of the first and second tab portions on a bottom side of the napkin holder. The tab portions have a width sized to fit between feet of the napkin holder. Further, printed advertisement is disposed on at least one of the top portion and side portions.

Another aspect of the present invention provides a method of displaying advertising on a napkin holder. The method includes positioning a top portion of an advertising display device over a top of the napkin holder and positioning side portions of the advertising display device over sides of the napkin holder. Tab portions overlap and bind with an attachment device across the bottom of the napkin holder. When in place, the advertising display device exhibits print advertising on at least one of the top portion and first and second side portions.

The forgoing embodiment and other embodiments, objects and aspects as well as features and advantages of the present invention will become further apparent from the following detailed description of various embodiments of the present invention. The detailed description and drawings are merely illustrative of the present invention, rather than limiting the scope of the present invention defined by the appended claims and equivalents thereof.

### BRIEF DESCRIPTION OF THE DRAWINGS

FIG. 1 illustrates the front side of one embodiment of an advertising display device in accordance with the present invention;

FIG. 2 illustrates the advertising display device of FIG. 1 in a partial display configuration;

FIG. 3 illustrates one embodiment of a napkin holder;

FIG. 4 illustrates the advertising display device of FIG. 1 in a advertising configuration around a napkin holder;

FIG. 5 illustrates a bottom view of the napkin holder and advertising display device shown in FIG. 4.

FIG. 6 illustrates another embodiment of an advertising display device in accordance with the present invention; and

FIG. 7 is a flow chart of one embodiment of a method of advertising on a napkin holder.

### DETAILED DESCRIPTION OF THE INVENTION

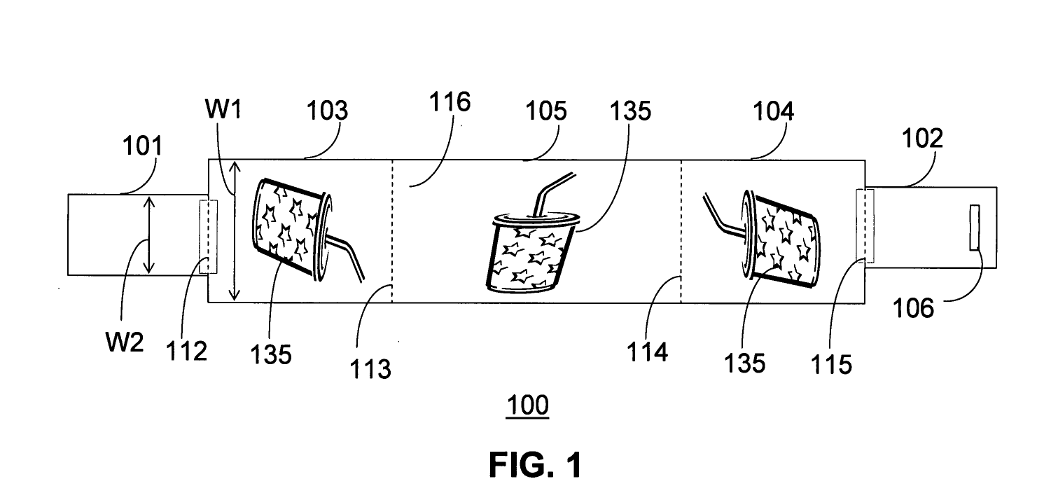

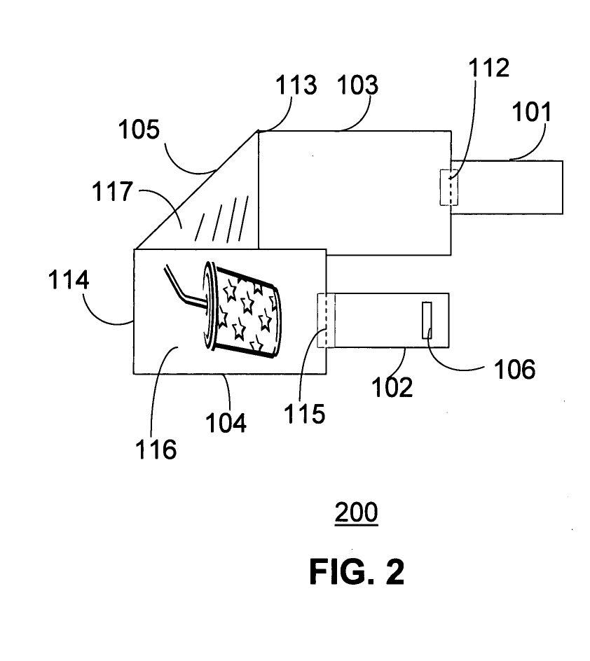

FIGS. 1 and 2 illustrate one embodiment of an advertising display device 100 made in accordance with the present invention. In FIG. 1, advertising display device 100 is illustrated in a flat position and in FIG. 2, advertising display device 100 is folded in a partial display configuration.

In one embodiment, advertising display device 100 comprises an elongated strip of material having a front side 116 and a back side 117. In one embodiment, advertising display device 100 includes score lines 112, 113,114, and 115. Score lines 112, 113, 114, and 115 divide advertising display device 100 into top portion 105, first side portion 103, second side portion 104, first tab portion 101 and second tab portion 102. Score lines 112, 113, 114, and 115 aid in folding advertising display device 100 as illustrated in FIG. 2. FIG. 2 illustrates advertising display device 100 folded at score lines 113 and 114.

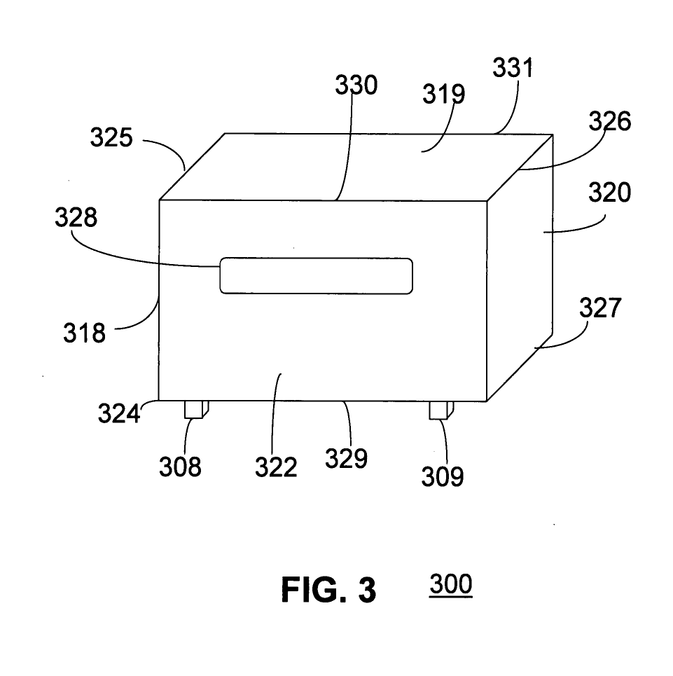

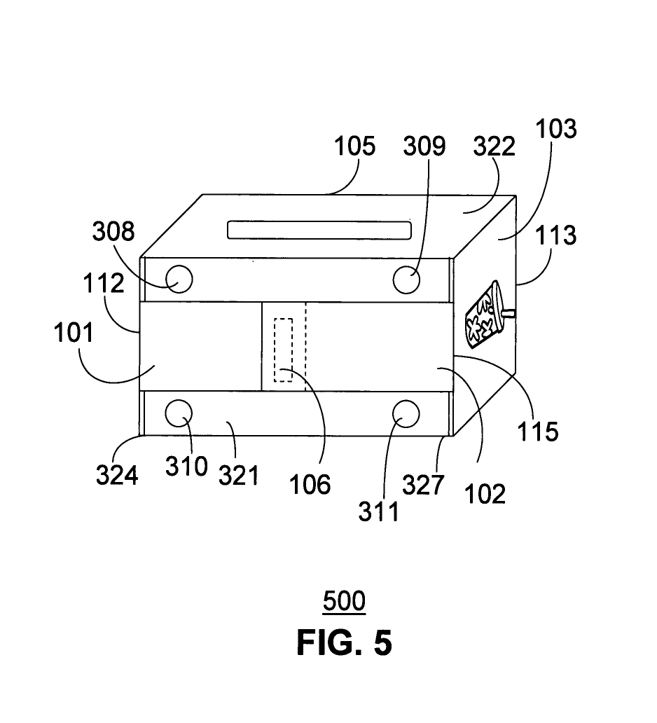

Advertising display device 100 is sized to fit around a napkin holder, as are known in the art. Referring now to FIG. 3, FIG. 3 illustrates one embodiment of a napkin holder 300 suitable for use with an advertising display device made in accordance with the present invention. In this embodiment, napkin holder 300 comprises a front 322, a back (not shown), a top 319, a first side 318, a second side 320, and a bottom 321 (see FIG. 5). Top 319 is defined by a first top edge 325, a second top edge 326, a third top edge 330, and a fourth top edge 331. Bottom 321 is defined by a first bottom edge 324, a second bottom edge 327, a third bottom edge 329, and a fourth bottom edge (not shown). Napkin holder 300 includes at least one opening 328 for dispensing napkins. Four feet 308, 309, 310 and 311 (see FIG. 5) are on bottom 321 of napkin holder 300.

Referring again to FIG. 1, top portion 105 of advertising display device 100 has a first length defined by score lines 113 and 114 to cover the top 319 of napkin holder 300 from a first top edge 325 to a second top edge 326, as seen in FIG. 3. First side portion 103 of advertising display device 100 has a second length defined by score lines 113 and 112 to cover first side 318 of the napkin holder from first top edge 325 to first bottom edge 324. Second side portion 104 of advertising display device 100 has a third length defined by score lines 114 and 115 to cover second side 320 of the napkin holder from second top edge 326 to second bottom edge 327.

In one embodiment, top portion 105 and side portions 103, 104 of advertising display device 100 have a first width W 1 and first tab portion 101 and second tab portion 102 have a second width W2. In one embodiment, width W2 of first tab portion 101 and second tab portion 102 is less than the first width W1 of the top portion 105 and side portions 103, 104 of advertising display device 100. As shown in FIG. 5, the reduced width W2 enables first tab portion 101 and second tab portion 102 to fit between the feet 308, 309, 310, and 311 located on the bottom of napkin holder 300, when the display device is in the display configuration.

Advertising display device 100 further includes an attachment device 106. In one embodiment, attachment device 106 is disposed on at least one of the first tab portion 101 and the second tab portion 102. The attachment device 106 secures first tab portion 101 to second tab portion 102 when advertising display device 100 is in the display configuration around the napkin dispenser. First tab portion 101 and second tab portion 102 bind at attachment device 106 at the bottom of the napkin holder 321. When bound together at attachment device 106, first tab portion 101 and second tab portion 102 overlap to cover the length of the bottom of the napkin holder 321. In one embodiment, attachment device 106 comprises double sided tape. In other embodiments, attachment device 106 may be, for example, tape, glue or hook and loop fasteners. Those with skill in the art will recognize that the arrangement of the attachment device 106 on the tab portions 101, 102 may take many configurations and is not limited to the embodiment illustrated in FIG. 2. In one embodiment, a hook portion of a hook and loop fastener is disposed on the first tab portion 101 and the loop portion is correspondingly disposed on the second tab portion.

Advertising display device 100 further includes advertising material 135. In one embodiment, advertising material 135 is disposed on at least one portion of the advertising display device 100. In one embodiment, advertising material 135 is disposed on the front side 116 of advertising display device 100. In one example, advertising material is disposed on first side portion 103, second side portion 104, and top portion 105. In one embodiment, the back side 117 of advertising display device 100 is devoid of advertising material. Advertising material is oriented in any manner viewable by a consumer and suitable for a particular application. The advertising material may be in color, grey scale or in black and white, as determined by the particular application.

Advertising display device 100 is composed of a printable material. In one embodiment, advertising display device 100 comprises a vinyl substrate material. In another embodiment, advertising display device 100 comprises 10 mil white vinyl substrate. In another embodiment, advertising display device 100 comprises printable styrene. Those with skill in the art will recognize that advertising display device 100 is made out of any suitable substrate that is durable and capable of having folds or creases. Use of white vinyl substrate, styrene, or similar effective substrate is preferred for exhibition of design and color and ease of cleaning of the advertising display device.

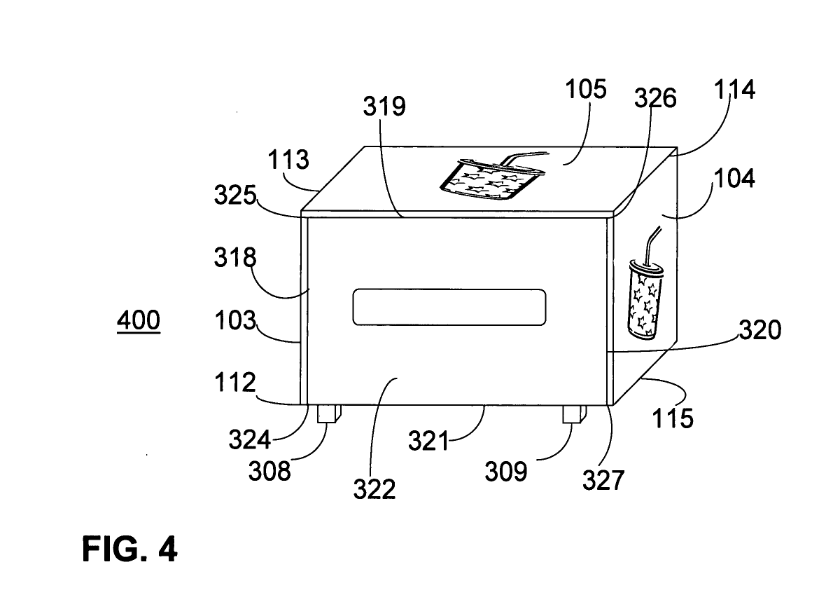

Referring now to FIGS. 4 and 5, FIG. 4 illustrates advertising display device 100 of FIG. 1 in a display configuration around the napkin holder 300 illustrated in FIG. 3. FIG. 5 illustrates a bottom view of the napkin holder 300 and advertising display device 100 shown in FIG. 4. In this embodiment, advertising display device 100 is folded at score lines 112, 113, 114 and 115 to place advertising display device in the display configuration. The advertising display device 100 is folded at the score lines in a direction opposite of the desired advertising to form a sleeve around at least a portion of the napkin holder. Top portion 105 of advertising display device 100 covers the top 319 of the napkin holder from first top edge 325 to second top edge 326. The advertising on top portion 105 faces up and is viewable to a consumer. Score line 113 of advertising display device 100 aligns with first top edge 325 of the napkin holder. Score line 114 of advertising display device 100 aligns with second top edge 326 of the napkin holder. First side portion 103 of advertising display 100 covers the length of first side 318 of the napkin holder from first top edge 325 to first bottom edge 324. Score line 112 of advertising display 100 aligns with first bottom edge 324 of the napkin holder. Second side portion 104 of the advertising display covers the length of second side 320 of the napkin holder from second top edge 326 to second bottom edge 327. First tab portion 101 and second tab portion 102 of advertising display device 100 overlap and are positioned between the feet 308, 309,310 and 311 (see FIG. 5) on the bottom 321 of the napkin holder. The first tab portion 101 and the second tab portion 102 bind at the attachment device 106. This enables advertising device 100 to remain on the napkin holder until such time as the advertising display device is removed.

In one embodiment, the front 322 and back of the napkin holder 300 remain exposed when advertising display device 100 is in the display configuration so that napkins are assessable to the consumer.

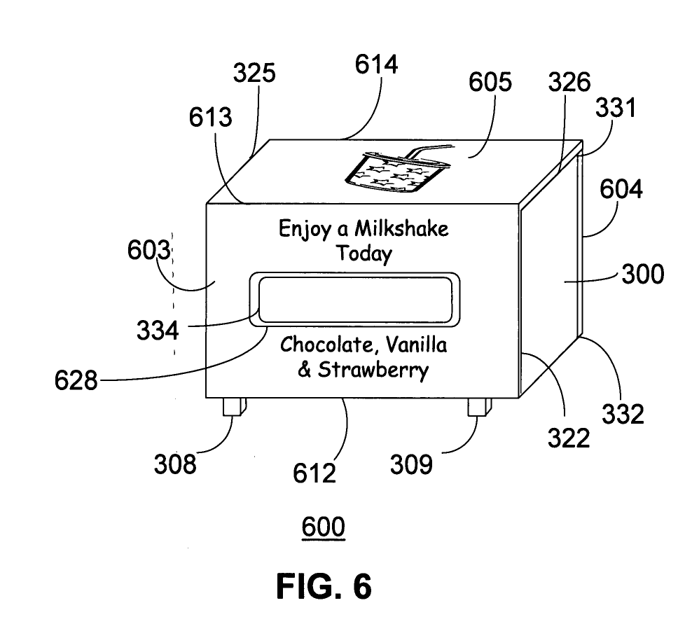

Referring now to FIG. 6 where like reference numbers refer to like elements as those of FIGS. 1-5, FIG. 6 illustrates another embodiment of an advertising display device 600, made in accordance with the present invention. Advertising display device 600 is illustrated in a display configuration covering the front 322 and back (not shown) of the napkin holder 300. Similar to advertising display device 100, advertising display device 600 includes three advertising portions 603, 604, 605. Advertising display device 600 is secured to the napkin holder in a manner similar to or the same as that of device 100 via first and second tab portions and an attachment device. In this embodiment, advertising material 635 is viewable from the front 322, top 326 and back (not shown) of the napkin holder. In one embodiment, the top portion 605 of advertising display 600 covers the length of the napkin holder 300 from first top edge 325 to second top edge 326. The first side portion 603 of advertising display device 600 covers the length of the front 322 of the napkin holder 300 from third top edge 330 to third bottom edge 329. First side score 613 of advertising display device 600 aligns with third top edge 330 of the napkin holder 300. Second side portion 604 of advertising display device 600 covers the length of the back (not shown) of the napkin holder 300 from fourth top edge 331 to fourth bottom edge332. Second side score 614 of the advertising display device 600 aligns with fourth top edge 331 of the napkin holder 300. The first tab portion and second tab portion fit in between the feet 308 and 309 on the bottom of the napkin holder 300. An attachment device 106 on one of the tab portions binds the two tab portions together. This enables the advertising display device to remain in place on the napkin holder until such time that it is removed.

In one embodiment, first side portion 603 of advertising display device 600 includes an opening 628 that corresponds to an opening 334 in the napkin holder through which napkins are dispensed. This permits the accessibility of napkins from the napkin holder 300 while immediately displaying advertising on at least the front 322 of the napkin holder 300.

Those with skill in the art will appreciate that there are other configurations of advertising display device contemplated by the present invention. For example, in another embodiment, advertising material is disposed on the front and back of the advertising display device. In this embodiment, once the advertising campaign or promotion is over, the user can remove the advertising display device from the napkin holder, turn the advertising display device over to reveal the back surface and re-secure the advertising display device thereby displaying the advertising that is on the back surface. This enables the switching of advertising material for present or future advertising campaigns. Advertising on the front and back of the advertising display device may also reduce costs since less advertising display devices will need to be produced, stored, and shipped.

In yet another embodiment, advertising material on the advertising display device is removable. In an example, the advertising material consists of multiple layers of material that can be pealed off to reveal another or the same advertising underneath. This enables the changing of all or partial advertising campaigns without the need for a new advertising display device. Removable advertising material can also be in the form of coupons, stickers, advertising, or the like that can be removed and used by the customer.

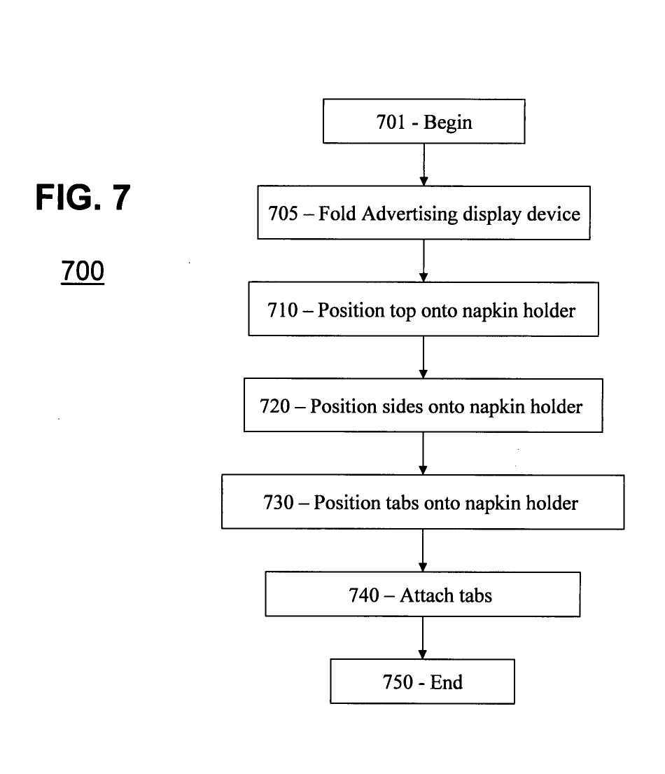

FIG. 7 illustrates a flow chart for one method 700 of advertising on a napkin holder in accordance with the present invention. Method 700 is described using advertising display device 100 illustrated in FIGS. 1-5. The method begins at step 701. At step 705, the advertising display device 100 is folded at all score lines 112. 113, 114, 115 in the direction opposite of the advertising 135 to be displayed. At step 710 the top portion 105 of the advertising display device is placed over the top of the napkin holder such that the desired advertising is viewable. The top portion 105 of the advertising display device covers the entire length of the top of the napkin holder. The first and second sides 103, 104, respectively, of the advertising display device are placed over the respective sides of the napkin holder at step 720. The first and second score lines of the advertising display device align with respective top edges of the napkin holder. Any desired advertising is viewable to the user. At step 730, tab portions 101, 102 on the advertising display device are placed between the feet on the bottom of the napkin holder. The first and second tab score lines of the advertising display device align with respective edges on the bottom of the napkin holder. At step 740, an attachment device 106 on the first tab portion is revealed (i.e, protective cover is removed from two-sided tape) and pressed against the second tab portion to secure the tabs of the advertising device together so that the advertising device remains in place on the napkin holder. Upon securing the tab portions together, the advertising display device covers the top and sides of the napkin holder thereby displaying the desired advertising. Method 700 ends at step 750.

While the embodiments of the present invention disclosed herein are presently considered to be preferred, various changes and modifications can be made without departing from the spirit and scope of the invention.

1. An advertising display device for a napkin holder, comprising:
a top portion having a length to extend across a top surface of the napkin holder;
a first side portion and a second side portion extending from the top portion, the side portions each having a length to extend across a side of the napkin holder;
a first tab portion extending from the first side portion;
a second tab portion extending from the second side portion;
an attachment device positioned on one of the first or second tab portion to allow attachment to the other of the first or second tab portion adjacent a bottom side of the napkin holder, wherein the first and second tab portions have a width sized to fit between a plurality of feet positioned on the bottom side of the napkin holder; and
at least one advertisement image disposed on at least one of the top portion, the first side portion and the second side portion.

2. The advertising display device of claim 1 wherein the width of the top portion and first and second side portion is sized to a width of the top and sides of the napkin holder.

3. The advertising display device of claim 1 wherein the device comprises material chosen from the group consisting of styrene and vinyl substrate.

4. The advertising display device of claim 1 wherein the device includes a first and a second side score and a first and second tab score.

5. The advertising display device of claim 1 wherein the width of the first and second tab portions is less than a width of the first and second side portions.

6. The advertising display device of claim 1 further comprising a plurality of removable advertising images disposed on at least one of the top portion, first side portion and second side portion.

7. The advertising display device of claim 1 wherein on the advertisement image is disposed on a front surface and a back surface of at least one of the top portion, first side portion and second side portion.

8. The advertising display device of claim 8 wherein both tab portions comprise an attachment device.

9. A method of displaying advertising on a napkin holder, the method comprising:
positioning a top portion of an advertising display device over a top of the napkin holder;
positioning first and second side portions of the advertising display device over sides of the napkin holder;
positioning first and second tab portions across a bottom of the napkin holder and between feet of the napkin holder;
attaching the first tab portion to the second tab portion with an attachment device; and
displaying print advertising on at least one of the top portion and first and second side portions of the advertising display device.

10. The method of claim 9 further comprising:
aligning first and second side scores of the advertising display device at first and second top side corners of the napkin holder; and
aligning first and second tab scores of the advertising display device with first and second bottom side corners of the napkin holder.

11. An advertising display device for a napkin holder, comprising:
top portion advertising means for displaying advertising on a top of a napkin holder;
side portion advertising means extending from the top portion advertising means for displaying advertising on at least one side of the napkin holder; and
tab attachment means extending from the side advertising means for securing the advertising display device to the napkin holder.
